(19) United States
(12) Patent Application Publication
(10) Pub. No.: US 2005/0141081 A1
(43) Pub. Date: Jun. 30, 2005

(54) Method for correcting drift in an optical device

(75) Inventor: Frank Olschewski, Heidelberg (DE)

Correspondence Address: HOUSTON ELISEEVA, 4 MILITIA DRIVE, SUITE 4, LEXINGTON, MA, 02421, US

(73) Assignee: Leica Microsystems Heidelberg GmbH, Mannheim (DE)

(21) Appl. No.: 11/007,736

(22) Filed: Dec. 8, 2004

(30) Foreign Application Priority Data
Dec. 27, 2003 (DE) DE10361327.7

(51) Int. Cl. G01N 23/00; G02B 21/00; G21K 7/00

(52) U.S. Cl. 359/368

(57) ABSTRACT

In an optical device (2), in particular a microscope, drift is sensed by the fact that a first image of an immovable specimen (30) is acquired at a first time (T(n-1)), and a second image thereof at a second time (T(n)). The drift is calculated from a comparison between the first and the second image.

### RELATED APPLICATIONS

This application claims priority of the German patent application 103 61 327.7 which is incorporated by reference herein.

### FIELD OF THE INVENTION

The invention concerns a method for correcting drift in an optical device, as defined in the preamble of claim 1, as well as a microscope having a device for correcting drift, as defined in the preamble of claim 12.

### BACKGROUND OF THE INVENTION

Optical devices, in particular microscopes, can also be regarded as mechanical assemblages that as a result of technically related limitations—for example the accuracy with which the housing is manufactured, or possible fitting inaccuracies when the individual parts are put together—act in quite stable fashion macroscopically, but nevertheless exhibit motions microscopically. These motions are often thermally dependent. These motions are, as a rule, referred to as “drift.” It must be noted in general, however, that drift as a rule is only an observed manifestation that is perceived, in the context of long-term observations of immovable portions of a specimen using a camera or a confocal scanner, as virtual motion of that specimen over time. This apparent motion of the specimen can be perceived by the user in the context of optical devices, and often results in complaints or in difficulties when evaluating images of specimens being examined.

Drift occurs as a visible result of the coaction of all the parts of an optical device. For example, one panel may expand as a result of heating and another may contract, and another component may move or in fact be deformed by the resulting forces. The result is perceived, however, only as a relatively small change in the X, Y, and Z direction.

A sophisticated mechanical design can be used to prevent drift, in which context the drift can often be reduced at least to a negligible level.

With increasing resolution and magnification, however, it becomes more and more difficult to achieve such a reduction in drift. The reason is that to do so, increasingly small motions of the optical device relative to the specimen must be detected and prevented, often requiring cost-intensive measures. In addition, there is a trend in present-day optical devices to use increasingly economical materials, metal parts often being replaced by plastic parts. This often results, however, in new effects that are difficult to evaluate and have a negative influence on drift.

The German Paten Application DE 199 59 228 discloses a laser scanning microscope that encompasses a temperature sensor whose signals accomplishes focus correction on the basis of stored reference values. The measured temperature change is converted into a modification of at least one component of the microscope (stage displacement, piezoelement positioning, mirror deformation, etc.) to be performed accordingly. Temperature compensation can likewise be accomplished by way of a stored table or curve. With this method, only the Z coordinate, i.e. the focus, can be kept constant. “Wandering” of the sample within the X-Y plane defined by the stage surface cannot be compensated for therewith.

DE Patent 195 301 36 C1 likewise describes a microscope having a focus stabilization system. Temperature stabilization is accomplished by way of two metal rods having different coefficients of thermal expansion. One rod is connected to the toothed rack for the focus drive, the other rod to the microscope stage. Focus stabilization is accomplished exclusively by mechanical means matched individually to the microscope.

The proposed drift correction systems also require that the drift be caused by a change in the sensed temperature. Temperature changes that are very small but result in a large drift thus cannot be adequately sensed and corrected. Drift that is attributable to other causes, for example a change in installation conditions or the coaction (as already described above) of parts of the microscope, therefore cannot be sensed.

### SUMMARY OF THE INVENTION

It is the object of the present invention to propose a method for correcting drift in optical devices that is independent of the cause of the drift.

According to the present invention, this object is achieved by a method for correcting drift in an optical device having the features according to Claim 1.

The principle of the method according to the present invention is therefore that firstly, two chronologically successive images of an immovable specimen are acquired. Both images are subdivided using a grid, producing on both images blocks whose centers are defined by coordinates, called “motion hypotheses.” One block of the second image is then selected and is compared with the blocks of the first image until the most similar block in the first image, called the “target block,” is found. If the comparison reveals that the coordinates of the block found in the first image agree with the coordinates of the block in the second image, the block has therefore not changed position, and no drift is present. If, however, the target block is in a different location, a vector can be identified that describes the displacement of that block as drift.

Although moving specimens can, in principle, also be used, it is advantageous to select immovable specimens. This is because with movable specimens, it must be considered that here drift could also be simulated by the specimen motion, which can be taken into account again, i.e. calculated out, only if the specimen's motion pattern is known. This is likely to be the case, however, in very few instances with the specimens being examined.

When the block of the second image is compared with all the blocks of the first image, it is possible to identify the so-called target block which meets the criterion of being the most similar to the initial block, i.e. the block of the second image. From a knowledge of the block coordinates, it is then possible to determine the vector that characterizes the drift.

For comparison of the blocks it is possible to use a number of methods that can identify whether the blocks compared with one another are similar to one another. An evaluation must also be made, however, that provides information as to how great the degree of similarity is, so that a decision can later be made as to which is the target block, i.e. which block is most similar to the initial block.

To enhance accuracy, it is possible to subdivide the target block further into sub-blocks, and to carry out the method again for these sub-blocks. This can be continued until no further improvement in similarity can be identified. For this instance, the drift is then obtained from the sum of the individual steps resulting from consideration of the sub-blocks.

Drift correction in the microscope can then be accomplished, for example, by calculating the drift out of the identified images as an apparent motion.

A microscope according to the present invention thus comprises an apparatus for acquiring a first and a second image. A device for correcting drift is also provided. This device is equipped with a unit for dividing the first and second images into blocks. A unit for comparing one block of the second image with the blocks of the first image allows the similarity between the blocks to be identified and evaluated.

The above-described microscope and method for correcting drift have the advantage that drift can be accurately sensed and corrected for very small values. The drift that is sensed is, moreover, independent of its cause, and in particular is not limited merely to temperature changes.

The direction of the drift can furthermore be determined, and corrected accordingly, in the X-Y direction as well.

### BRIEF DESCRIPTION OF THE DRAWINGS

Further advantages and advantageous embodiments of the invention are the subject matter of the Figures below and their descriptions. In the individual Figures:

FIG. 1 is a schematic view of an example of the microscope having a device for sensing and correcting drift;

FIG. 2 shows the basic method sequence for determining drift;

FIGS. 3a)-c) schematically depict a motion estimator;

FIG. 4 schematically depicts a motion estimator with subdivision into sub-blocks;

FIG. 5 schematically depicts the drift correction system in a conventional microscope;

FIG. 6 schematically depicts an alternative drift correction system in a confocal microscope.

### DETAILED DESCRIPTION OF THE INVENTION

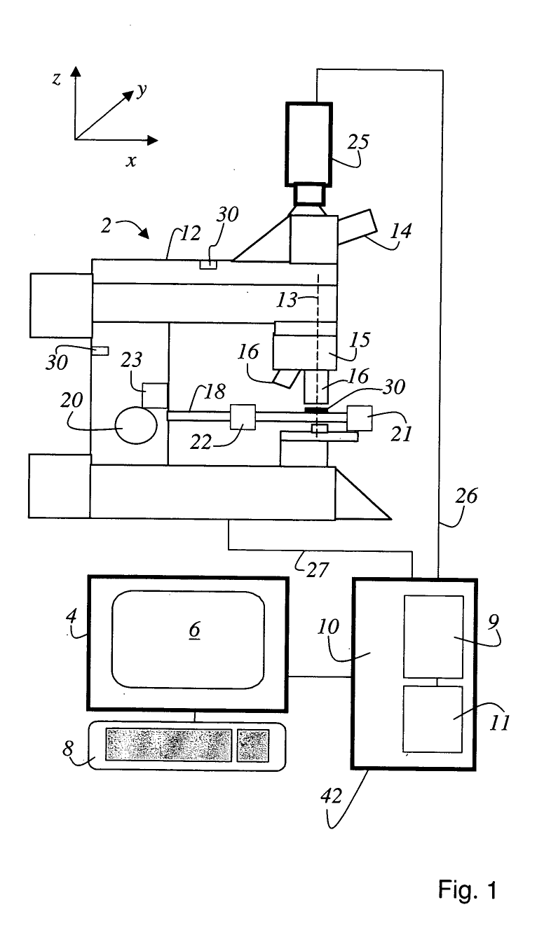

FIG. 1 schematically depicts a microscope as optical device 2. In the exemplary embodiment shown here, microscope 2 has associated with it a computer 4 with display 6 and an input means 8, as well as a control and monitoring unit 10 for controlling the various microscope functions. Control and monitoring unit 10 encompasses a memory 9 and a microprocessor 11. It is self-evident that microscope 2 can have any conceivable form and equipment, and the depiction in FIG. 1 is not to be construed as a limitation. Microscope 2 encompasses a stand 12 on which at least one eyepiece 14, at least one objective 16, and a microscope stage 18 displaceable in all three spatial directions are provided. A specimen 30 to be microscopically examined or treated can be placed on microscope stage 18. As schematically depicted by the coordinate system, the X-Z direction extends in the drawing plane. In this depiction, the Y direction runs perpendicular to the drawing plane. In the exemplary embodiment depicted here, microscope 2 encompasses a nosepiece 15 on which several objectives 16 are mounted. One of objectives 16 is in a working position and defines an optical axis 13. Provided on each side of stand 12 is an adjustment knob 20 with which microscope stage 18 can be displaced in elevation (in the Z direction) relative to objective 16 in the working position. Microscope stage 18 of microscope 2 can be displaced with a first motor 21 in the X direction, with a second motor 22 in the Y direction, and with a third motor 23 in the Z direction. Activation of the first, second, and third motors 21, 22, and 23 is accomplished via control and monitoring unit 10. Connected to microscope 2 is a camera 25 that acquires an image of specimen 30 being observed with objective 16. Camera 25 is connected to control and monitoring unit 10 via a first electrical connection 26. Control and monitoring unit 10 is likewise connected to microscope 2 via a second electrical connection 27, through which signals from microscope 2 to control and monitoring unit 10, and signals from monitoring and control unit 10 to microscope 2, are delivered. It is self-evident that camera 25 can be a video camera or a CCD camera. Data supplied by camera 25 and, if applicable, correlated by microprocessor 11 can be stored in memory 9. These data encompass values of two successive images of specimen 30 and, if applicable, the comparison values of those images. In the exemplary embodiment depicted in FIG. 1, control and monitoring unit 10 are is housed in an external electronics box 42 connected to microscope 2.

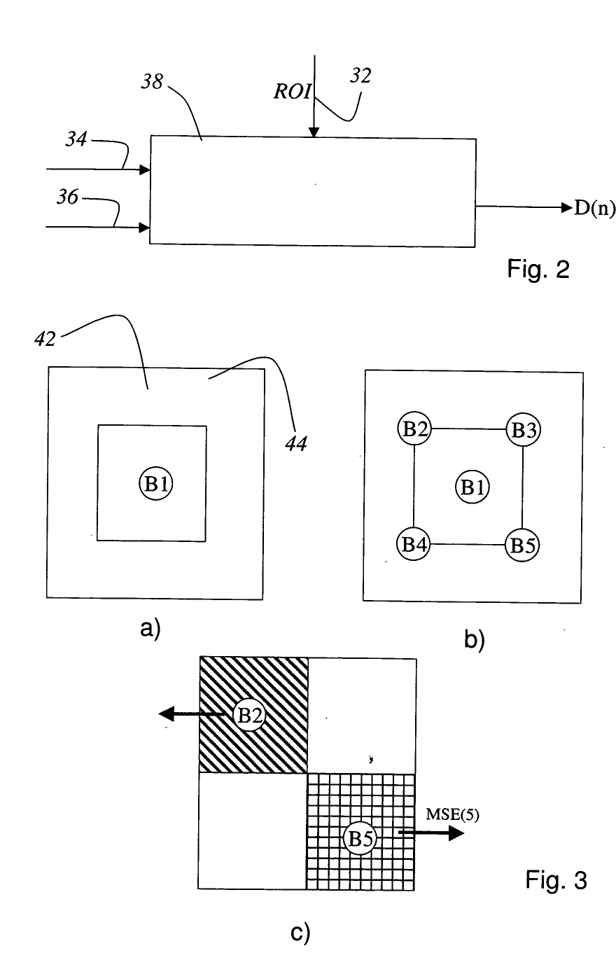

As already mentioned, the entirety of the components of microscope 2 can cause a drift. The basic method for determining drift according to the present invention is shown in FIG. 2. In this, firstly two chronologically successive images of a region of interest of specimen 30 are acquired, that region usually being abbreviated ROI. Selection of the ROI is made in step 32, preferably by the user. In a further step, a first image is then acquired, preferably in pixel coordinates, of this ROI at a first time T(n-1), and a second image thereof at a second time T(n). The ROI selected is preferably parallelepipedal. In a device 38 for calculating drift, the data obtained at the first and the second time are processed, and the current drift d(n) is calculated therefrom. Image values are thus identified for the discrete times T(n-1) and T(n); those values can be represented, for example, as intensity values I(x,y,T(n-1)) and I(x,y,T(n)). These are conveyed, in steps 34 for I(x,y,T(n-1)) and 36 for I(x,y,T(n)), to device 38 for calculating drift. A prerequisite for carrying out this method is that an immovable specimen be present within the ROI, and that the ROI have a detectable image content, i.e., in particular, not be completely black. If only a movable specimen is present in the ROI, the inherent motion of the specimen simulates a drift that can be further evaluated only if the sequence of the specimen's motion over time is known, although that is not the case in the overwhelming number of instances.

The current drift d(n) is calculated using a motion estimator in which the motion of the specimen monitored by comparing blocks in terms of their similarity. This is done by first subdividing the first and the second image of the selected ROI into blocks. A comparison is then made between one block of the first image and all the blocks of the second image, in which comparison the degree of similarity that exists between the compared blocks is ascertained. In other words, a search is made for the image segment that is most similar to the scene from the last image. The indicator of similarity between two blocks that is used, for example, the mean squared error for a predetermined ROI and a drift vector d that is to be evaluated. The mean squared error (MSE) can be represented as follows:

$$MSE ( ROI , \vec{d} = {\sum }_{\vec{x} ∈ ROI} {( I ( \vec{x} , T ( n - 1 ) ) - I ( \vec{x} + \vec{d} , T ( n ) ) )}^{2}$$

The principle of this motion estimator is depicted in FIG. 3, it being necessary to identify the set of all possible displacement vectors.

As is evident from FIG. 3a), this is done by defining, from predefined ROI 40, a first block 42 that is at least half as large as predefined ROI 40. This first block 42 is positioned in the center of predefined ROI 40. With center B1 and its corners B2, B3, B4, and B5, first block 42 thus defines five motion hypotheses, as depicted in FIG. 3b). Centers B1 through B5 constitute five motion hypotheses for a possible motion that can be accomplished between the first and the second image. These five motion hypotheses must then be evaluated, i.e. the probability of a motion in directions B1 through B5 is ascertained by comparison. An MSE is correspondingly identified for each motion hypothesis, so that in total, motion hypotheses MSE(1) through MSE(5) are identified using the equation above. MSE(2) and MSE(5), as identified, are depicted schematically in FIG. 3c). As already discussed, however, the calculation must be performed for all the motion hypotheses B1 through B5.

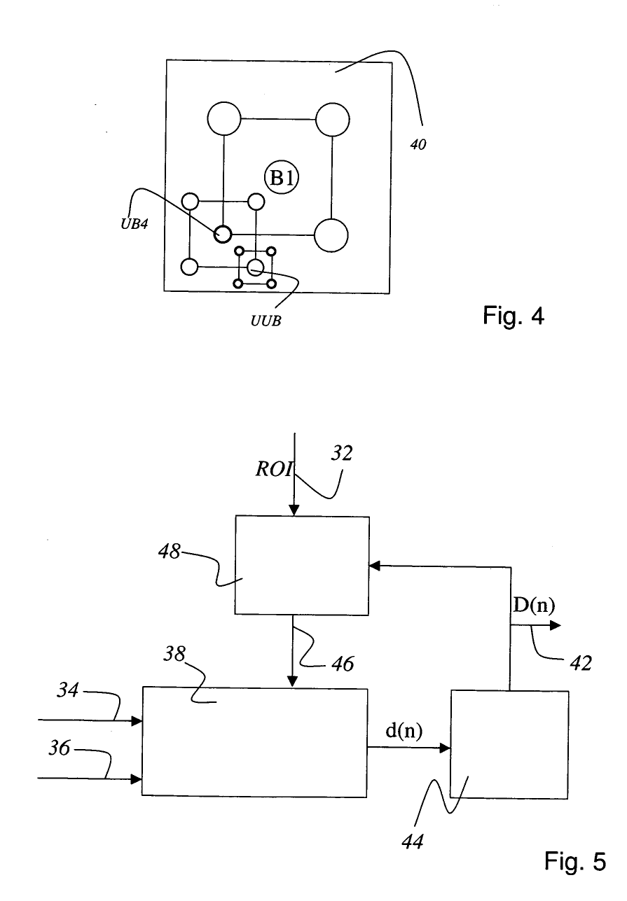

As soon as all the motion hypotheses are tested, a determination can be made as to which block is the target block, i.e. for which block the MSE is lowest. The current drift vector d(n) is thus defined for this target block. The procedure can then continue in the same way in this target block. This is done, as shown in FIG. 4 using the example of block B4, by halving the original target block size. Then in turn, as already described in connection with FIG. 3, five sub-blocks are generated in the space of target block B4. All five motion hypotheses are once again tested, and the target sub-block is identified on the basis of the test. The current drift vector d(n) is thus defined again for the target sub-block just identified in this fashion, and the procedure can continue accordingly with further sub-blocks UUB.

If this method is continued in successive and recursive fashion, the identification of the respective target blocks yields a number of drift vectors whose sum represents the total drift, the surface of the ROI being tiled with hypotheses. If one begins, for example, with an ROI having a pixel size of 14×14, the method can be continued until a pixel size of 2×2 is attained for the smallest block. The drift vector is thus identified after a maximum of 25 operations on successively smaller and smaller blocks.

The drift thus identified is then compensated for in the microscope. This can be done, for example, by calculating the drift out in a subsequent calculation step that is performed, in particular, in a calculation unit of the microscope. Control and monitoring unit 10 of microscope 2 can be used here, for example.

FIG. 5 once again depicts a possible overall method sequence for a conventional microscope 2. This involves firstly, in step 32, selecting an ROI on screen 6. After selection, the above-described algorithm for drift compensation is executed. It is essential in this context, however, that an immovable feature of specimen 30 be selected by the user. A determination is made in a displacer 48, using a displacement protocol adapted to the algorithm used, of the magnitude and direction required for displacement in the next motion estimation step. This depends substantially on the position of the identified target block. Displacement then occurs in step 46. The current drift d(n) is then calculated using the motion estimator, in which the motion of the specimen is accomplished by way of the comparison (already described) of blocks B1 through B5 in terms of their similarity. This is done by comparing, in device 38 for calculating drift, the intensity values of first image 34 and of second image 36 of the selected ROI for the blocks to be compared, and thus determining the minimum discrepancy. It is thereby possible to find the image segment that is most similar to the scene from the last image. The current drift vector d(n) resulting therefrom is conveyed to an integrator 44 in which the total drift D(n) resulting from the sum of all individual drifts d(n) is identified. This total drift D(n) is stored for later correction in step 42.

Since the total drift D(n) of microscope 2 is now known, it can be taken into account in the depiction of any specimens (including movables ones) by calculating it out of the image in a subsequent step after imaging of the specimen.

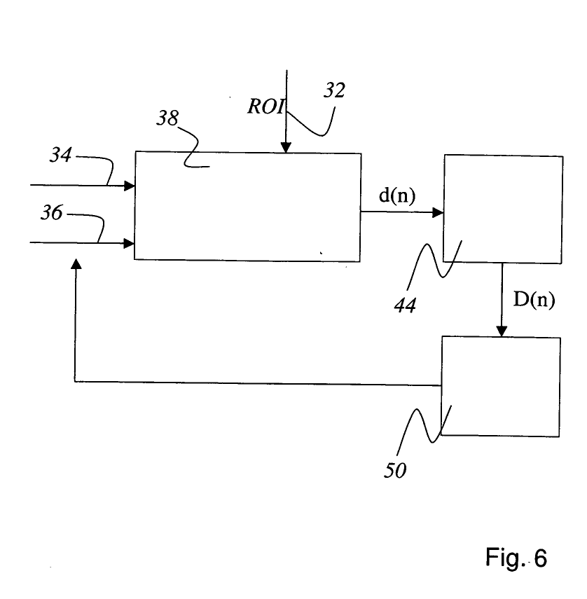

FIG. 6 depicts an alternative procedure for drift correction in a confocal microscope. Imaging in such microscopes is usually performed using so-called galvanometers, which direct a light beam incident onto the specimen in such a way that it illuminates the specimen line by line. The galvanometer is actively controlled for this purpose, so that every point on the specimen can be collected. This active control can now be integrated into the process of drift identification and correction in the context of the degrees of freedom of motion of the galvanometers, displacer 48 shown in FIG. 5 being omitted, and that function being integrated into the galvanometer control system. After selection of an ROI in step 32, the current drift d(n) is once again identified in device 38 for calculating drift. The current drift d(n) is conveyed to integrator 44, which identifies the respective current total drift D(n) by integration. This result is transmitted to galvanometer control system 50, so that the total drift can be taken into account upon positioning of the mirrors. The algorithm thus always operates in the same block. The scanner that scans the specimen, however, senses images displaced in analog fashion.

It is also possible, in principle, to reconfigure the control system in a confocal microscope in such a way that two different images are acquired in successive sequence. For this purpose, the first image is acquired directly from the sample itself, while the second image is obtained from the intermediate image plane. The overall sequence of acquired images can then be generated in such a way that in a successive sequence of sample images, a reference image is acquired from the intermediate image plane and is employed for drift determination. In this case an immovable specimen is definitely present, and the image can be restricted to the number of pixels relevant for drift determination.

1. A method for correcting drift in an optical device, in particular in a microscope, comprises the steps of:
acquiring a first image of a specimen at a first time (T(n-1));
acquiring chronologically successively to the first image a second image thereof at a second time (T(n));
subdividing the first and the second image by using a grid, and one block (B1) of the second image is compared with the blocks (B1-B5) of the first image; and
calculating and correcting the drift (D(n)) from that comparison.

2. The method for correcting drift as defined in claim 1, wherein the specimen is immovable.

3. The method for correcting drift as defined in claim 1, wherein the block (B1) of the second image is compared with the blocks (B1-B5) of the first image, and from that comparison an identification is made, from the blocks of the first image, of a target block that is most similar to the block of the second image.

4. The method for correcting drift as defined in claim 3, wherein the target block is identify by a weighted comparison between the block of the second image and the blocks of the first image.

5. The method for correcting drift as defined in claim 4, wherein the mean squared error (MSE) is used as the indicator for the similarity of blocks (B1-5).

6. The method for correcting drift as defined in claim 3, wherein the target block is identified in iterative steps using increasingly smaller segments each time.

7. The method for correcting drift as defined in claim 1, wherein a total drift (D(n)) is determined in several individual steps, and is identified by an integration of individual drifts (d(n)).

8. The method for correcting drift as defined in claim 1, wherein the drift is corrected by being calculated out of the second image, in particular in a calculation step following drift determination.

9. The method for correcting drift as defined in claim 1, wherein in the comparison of the blocks of the first and the second image, the similarity of the blocks is determined.

10. The method for correcting drift as defined in claim 7, wherein the individual steps are determined by a predefined similarity of the blocks of the first and the second image.

11. The method for correcting drift as defined in claim 1, wherein the first image is obtained from the sample itself, and the second image from an intermediate image plane.

12. A microscope comprising:
an apparatus for acquiring a first and a second image;
a device for correcting drift, which has a unit for dividing the first and second images into blocks,
a unit for comparing one block (B1) of the second image with the blocks (B1-B5) of the first image, and
a unit for identifying the similarity of the first and the second image.

13. The microscope as defined in claim 12, wherein an integrator is provided for integrating individual drift (d(n)) to yield a total drift (D(n)).

14. The microscope as defined in claim 12, wherein a displacer is provided.

15. The microscope as defined in claim 12, wherein the microscope is embodied as a confocal microscope, and a galvanometer is provided that is supplied with the values identified in the integrator and/or with values corresponding thereto.
